(19) United States
(12) Patent Application Publication
(10) Pub. No.: US 2025/0019522 A1
(43) Pub. Date: Jan. 16, 2025

(54) A RUBBER COMPOSITION

(71) Applicant: COMPAGNIE GENERALE DES ETABLISSEMENTS MICHELIN, Clermont-Ferrand (FR)

(72) Inventors: YOSHIKO MAETA, TOKYO (JP); KARIM EL-OTHMANI, Clermont-Ferrand (FR)

(21) Appl. No.: 18/714,385

(22) PCT Filed: Nov. 30, 2021
(86) PCT No.: PCT/JP2021/043950

§ 371 Date: May 29, 2024

(51) Int. Cl. C08K 5/372; B60C 1/00; C08K 3/04; C08L 23/22

(52) U.S. Cl. CPC C08K 5/3725; C08K 3/04; C08L 23/22; B60C 1/0008

(57) ABSTRACT

A rubber composition, which allows a sufficient scorch time while being maintaining or improving the curing time, the breaking energy performance, the performance of permeability to oxygen and the hysteresis performance, is based on at least an elastomer matrix, a reinforcing filler, a plasticizing agent and a crosslinking system. The plasticizing agent comprises a hydrocarbon resin comprising more than 0.0 phr and less than 20 phr of a tackfying resin, and the crosslinking system comprises a vulcanizing agent comprising more than 0.0 phr and less than 10 phr of a sulfur donor comprising N,N′-Caprolactam disulfide.

### TECHNICAL FIELD

The field of the invention is that of rubber compositions, particularly rubber compositions for rubber products, more particularly rubber compositions for rubber products, still more particularly rubber compositions for tires, shoes, rubber tracks or industrial rubber products, especially rubber compositions for tires, more especially rubber compositions for tire inner liners.

### BACKGROUND

A constant objective of manufacturers for rubber products is to secure the sufficient scorch time while maintaining or improving (shortening) the curing time because each is its counter performance of the other.

### CITATION LIST

### Patent Literature

PTL 1: JP2004-018682

The patent literature 1 discloses a rubber composition which comprise a diene rubber and a cobalt salt of an aliphatic or alicyclic carboxylic acid and an aromatic carboxylate, and which can be increased the scorch time and shortened the curing time.

However, the patent literature 1 also discloses the rubber composition can make the other performances (for example, breaking stress and elongation at break) degraded.

### SUMMARY OF INVENTION

### Technical Problem

During their research, the inventors have discovered that a specific rubber composition intended in particular for a rubber product, in more particular for a tire, a shoe, a rubber track or an industrial rubber product, in still more particular for a tire inner liner, which allows being secured the sufficient scorch time while being maintained or improved the curing time, the breaking energy performance, the performance of impermeability to oxygen and the hysteresis performance.

The expression “based on” or “composition based on” should be understood as meaning a composition comprising the mixture, the product of the in situ reaction of the various base constituents used or both, some of these constituents being able to react, being intended to react, or being intended to react and being intended to react with one another, at least partially, during the various phases of manufacture of the composition or during the subsequent curing, modifying the composition as it is prepared at the start. Thus, the compositions as employed for the invention can be different in the non-crosslinked state and in the crosslinked (vulcanized) state.

The term “phr” means part by weight per hundred parts of elastomers, within the meaning of the preparation of the composition before curing. That is to say, in the case of the presence of one or more elastomers in one or more additives, that the term “phr” means part by weight per hundred parts of “new” elastomers, thus excluding from the base 100 the elastomers contained in the additives.

In the present description, unless expressly stated otherwise, all the percentages (%) indicated are percentages by weight (wt %).

The expression “elastomer matrix” is understood to mean, in a given composition, all of the elastomers present in said rubber composition.

In the present description, unless expressly indicated otherwise, each Tg_{DSC} (glass transition temperature) is measured in a known way by DSC (Differential Scanning calorimetry) in accordance with Standard ASTM D3418-08.

Any interval of values denoted by the expression “between a and b” represents the range of values of more than “a” and of less than “b” (i.e. the limits a and b excluded) whereas any interval of values denoted by the expression “from a to b” means the range of values going from “a” to “b” (i.e. including the strict limits a and b).

When reference is made to a “predominant” compound, this is understood to mean, within the meaning of the present invention, that this compound is predominant among the compounds of the same type in the composition, that is to say that it is the one which represents the greatest amount by weight among the compounds of the same type, and preferably more than 50% by weight, more preferably more than 75% by weight. Thus, for example, a predominant polymer is the polymer representing the greatest weight, with respect to the total weight of the polymers in the composition. In the same way, a “predominant” filler is the one representing the greatest weight among the fillers of the composition. By way of example, in a system comprising just one polymer, the latter is predominant within the meaning of the present invention and, in a system comprising two polymers, the predominant polymer represents more than half of the weight of the polymers. On the contrary, a “minor” compound is a compound which does not represent the greatest fraction by weight among the compounds of the same type.

Within the meaning of the present invention, when reference is made to a “predominant” unit (or monomer) within one and the same compound (or polymer), this is understood to mean that this unit (or monomer) is predominant among the units (or monomers) forming the compound (or polymer), that is to say that it is the one which represents the greatest fraction by weight among the units (or monomers) forming the compound (or polymer). Thus, for example, a resin predominantly composed of units resulting from C, monomers is a resin in which the C₅ units represent the greatest amount by weight among all the units making up the said resin.

In other words, a “predominant” monomer or an assembly of “predominant” monomers is a monomer (or an assembly of monomers) which represents the greatest fraction by weight in the polymer. On the contrary, a “minor” monomer is a monomer which does not represent the greatest molar fraction in the polymer.

The compounds mentioned in the description may be of fossil or biobased origin. In the latter case, they may partially or completely result from biomass or be obtained from renewable starting materials resulting from biomass. Polymers, plasticizers, fillers, and the like, are concerned in particular.

### Solution to Problem

A first aspect of the invention is a rubber composition based on at least an elastomer matrix, a reinforcing filler, a plasticizing agent and a crosslinking system; wherein plasticizing agent comprises a hydrocarbon resin comprising more than 0.0 phr and less than 20 phr of a tackfying resin; and wherein the crosslinking system comprises a vulcanizing agent comprising more than 0.0 phr and less than 10 phr of a sulfur doner comprising N,N′-Caprolactam disulfide.

### Advantageous Effects of Invention

The specific rubber composition allows being secured the sufficient scorch time while being maintained or improved the curing time, the breaking energy performance, the performance of impermeability to oxygen and the hysteresis performance.

### DESCRIPTION OF EMBODIMENTS

Each of the below aspect(s), the embodiment(s), the instantiation(s), and the variant(s) including each of the preferred range(s), matter(s) or both may be applied to any one of the other aspect(s), the other embodiment(s), the other instantiation(s) and the other variant(s) of the invention unless expressly stated otherwise.

The rubber composition according to the invention is based on an elastomer matrix.

As is customary, the terms “elastomer” and “rubber”, which are interchangeable, are used without distinction in the text.

Elastomer (or loosely “rubber”, the two terms being regarded as synonyms) of the “diene” type is to be understood in a known manner as an (meaning one or more) elastomer derived at least partly (i.e. a homopolymer or a copolymer) from diene monomers (monomers bearing two carbon-carbon double bonds, conjugated or not).

These diene elastomers may be classified into two categories: “essentially unsaturated” or “essentially saturated”. Generally, the expression “essentially unsaturated” is understood to mean a diene elastomer resulting at least in part from conjugated diene monomers having a content of units of diene origin (conjugated dienes) which is more than 15% (mol %); thus it is that diene elastomers such as butyl rubbers or diene/α-olefin copolymers of the EPDM type do not fall under the preceding definition and may especially be described as “essentially saturated” diene elastomers (low or very low content of units of diene origin, always less than 15%). In the category of “essentially unsaturated” diene elastomers, the expression “highly unsaturated” diene elastomer is understood to mean in particular a diene elastomer having a content of units of diene origin (conjugated dienes) which is more than 50%.

Although it applies to any type of diene elastomer, it is preferably employed with essentially unsaturated diene elastomers.

Given these definitions, the expression diene elastomer capable of being used in the compositions in accordance with the invention is understood in particular to mean:
(a) any homopolymer obtained by polymerization of a conjugated diene monomer, preferably having from 4 to 12 carbon atoms;
(b) any copolymer obtained by copolymerization of one or more conjugated dienes with one another or with one or more vinyl aromatic compounds preferably having from 8 to 20 carbon atoms.

The following are suitable in particular as conjugated dienes: 1,3-butadiene, 2-methyl-1,3-butadiene, 2,3-di(C₁-C₈ alkyl)-1,3-butadienes, such as, for example, 2,3-dimethyl-1,3-butadiene, 2,3-diethyl-1,3-butadiene, 2-methyl-3-ethyl-1,3-butadiene or 2-methyl-3-isopropyl-1,3-butadiene, an aryl-1,3-butadiene, 1,3-pentadiene or 2,4-hexadiene. The following, for example, are suitable as vinylaromatic compounds: styrene, ortho-, meta- or para-methylstyrene, the “vinyltoluene” commercial mixture, para-(tert-butyl) styrene, methoxystyrenes, chlorostyrenes, vinylmesitylene, di-vinylbenzene or vinylnaphthalene.

A second aspect of the invention is the rubber composition according to the first aspect, wherein the elastomer matrix comprises at least one butyl rubber, preferably wherein the total amount of the butyl rubber is more than 50 phr.

The butyl rubber is understood in known manner to mean a copolymer of isobutylene monomers and isoprene monomers (abbreviated to IIR), and the copolymer predominantly composed of isobutylene monomers.

According to a preferred embodiment of the second aspect, the butyl rubber comprises at least one halogenated butyl rubber, preferably the halogenated butyl rubber is selected from the group consisting of a chlorinated butyl rubber (CIIR), a brominated butyl rubber (BIIR) and a combination thereof, more preferably the halogenated butyl rubber is selected from the group consisting of a brominated butyl rubber (BIIR) and a combination thereof, still more preferably the halogenated butyl rubber is a brominated butyl rubber (BIIR).

According to a preferred embodiment of the second aspect, the total amount of the butyl rubber is more than or equal to 55 phr, preferably more than 55 phr, more preferably more than or equal to 60 phr, still more preferably more than 60 phr, particularly more than or equal to 65 phr, more particularly more than 65 phr, still more particularly more than or equal to 70 phr, advantageously more than 70 phr, more advantageously more than or equal to 75 phr, still more advantageously more than 75 phr, especially more than or equal to 80 phr.

According to a preferred embodiment of the second aspect, the total amount of the butyl rubber is less than or equal to 100 phr, preferably less than 100 phr, more preferably less than or equal to 95 phr, still more preferably less than 95 phr, particularly less than or equal to 90 phr, more particularly less than 90 phr, still more particularly less than or equal to 85 phr, advantageously less than 85 phr, more advantageously less than or equal to 80 phr.

A third aspect of the invention is the rubber composition according to the first aspect or the second aspect, wherein the elastomer matrix comprises at least one elastomer selected from the group consisting of an isoprene elastomer and a butadiene elastomer, preferably wherein the total amount of the elastomer is less than 50 phr.

According to a preferred embodiment of the third aspect, wherein the elastomer matrix comprises at least one elastomer being an isoprene elastomer.

The isoprene elastomer is understood to mean all the elastomers predominantly composed of isoprene monomers.

According to a more preferred embodiment of the third aspect or the above preferred embodiment, the isoprene elastomer is selected from the group consisting of isoprene polymers, isoprene copolymers and combinations thereof.

According to a still more preferred embodiment of the above more preferred embodiment, the isoprene copolymers are selected from the group consisting of butadiene isoprene copolymers (BIR), styrene isoprene copolymers (SIR), styrene butadiene isoprene copolymers (SBIR) and combinations thereof.

According to a particular embodiment of the above still more preferred embodiment, the butadiene isoprene copolymers (BIR) have an isoprene content of more than 50% by weight and less than 90% by weight per 100% by weight of the butadiene isoprene copolymers (BIR).

According to a particular embodiment of the above still more preferred embodiment, the butadiene isoprene copolymers (BIR) have a Tg_{DSC} of from −80° C. to −40° C.

According to a particular embodiment of the above still more preferred embodiment, the styrene isoprene copolymers (SIR) have a styrene content of more than 5% by weight and less than 50% by weight per 100% by weight of the styrene isoprene copolymers (SIR).

According to a particular embodiment of the above still more preferred embodiment, the styrene isoprene copolymers (SIR) have a Tg_{DSC} of more than −50° C. and less than-25° C.

According to a particular embodiment of the above still more preferred embodiment, the styrene butadiene isoprene copolymers (SBIR) have an isoprene content which is more than the styrene and butadiene content.

According to a particular embodiment of the above still more preferred embodiment, the styrene butadiene isoprene copolymers (SBIR) have an isoprene content of more than 50% by weight and less than 60% by weight per 100% by weight of the styrene butadiene isoprene copolymers (SBIR).

According to a more preferred embodiment of the third aspect or the above preferred embodiment, the isoprene elastomer is selected from the group consisting of natural rubber, synthetic polyisoprenes and combinations thereof, preferably the isoprene elastomer consists of natural rubber.

According to a still more preferred embodiment of the more preferred embodiment, the synthetic polyisoprene is a synthetic polyisoprene, preferably having a content (mol %) of cis-1,4 bonds of more than 90%, more preferably more than 95%, still more preferably more than 98%.

According to a preferred embodiment of the third aspect, wherein the elastomer matrix comprises at least one elastomer being a butadiene elastomer.

The butadiene elastomer is understood to mean all the elastomers predominantly composed of butadiene monomers.

According to a more preferred embodiment of the third aspect or the above preferred embodiment, the butadiene elastomer is selected from the group consisting of butadiene polymers, butadiene copolymers and combinations thereof, preferably selected from the group consisting of polybutadienes (BR), styrene butadiene copolymers (SBR) and combinations thereof.

According to a still more preferred embodiment of the above more preferred embodiment, the butadiene elastomer is selected from the group consisting of polybutadienes (BR) and combinations thereof.

According to a particular embodiment of the above still more preferred embodiment, the polybutadienes have a content (mol %) of 1,2-units of more than 4% and less than 80%.

According to a particular embodiment of the above still more preferred embodiment, the polybutadienes have a cis-1,4-content (mol %) of more than 80%

According to a still more preferred embodiment of the more preferred embodiment, the butadiene copolymer is selected from the group consisting of styrene butadiene copolymers (SBR), butadiene isoprene copolymers (BIR), styrene butadiene isoprene copolymers (SBIR) and combinations thereof.

According to a particular embodiment of the above still more preferred embodiment, the butadiene copolymer is selected from the group consisting of styrene butadiene copolymers (SBR) and combinations thereof.

According to a more particular embodiment of the above particular embodiment, the styrene butadiene copolymers (SBR) have a glass transition temperature Tg_{DSC} of more than −100° C. and less than 0° C., preferably more than −90° C. and less than 0° C., more preferably more than −80° C. and less than 0° C., still more preferably more than −70° C. and less than 0° C., particularly more than −60° C. and less than −10° C.

According to a more particular embodiment of the above particular embodiment, the styrene butadiene copolymers (SBR) have a styrene content of more than 5% by weight and less than 60% by weight, more particularly more than 20% by weight and less than 50% by weight, per 100% by weight of the styrene butadiene copolymers (SBR).

According to a more particular embodiment of the above particular embodiment, the styrene butadiene copolymers (SBR) have a content (mol %) of 1,2-bonds of the butadiene part of more than 4% and less than 75% and a content (mol %) of trans-1,4-bonds of more than 10% and less than 80%.

According to a particular embodiment of the above still more preferred embodiment, the butadiene copolymer is selected from the group consisting of butadiene isoprene copolymers (BIR) and combinations thereof.

According to a more particular preferred embodiment of the above particular embodiment, the butadiene isoprene copolymers (BIR) have an isoprene content of more than 5% by weight and less than 50% by weight per 100% by weight of the butadiene isoprene copolymers (BIR).

According to a more particular embodiment of the above particular embodiment, the butadiene isoprene copolymers (BIR) have a Tg_{DSC} of from −80° C. to −40° C.

According to a particular embodiment of the above still more preferred embodiment, the butadiene copolymer is selected from the group consisting of styrene butadiene isoprene copolymers (SBIR) and combinations thereof. The styrene butadiene isoprene copolymers (SBIR) have a butadiene content which is more than the styrene and isoprene content.

According to a preferred embodiment of the third aspect, wherein the total amount of the elastomer is less than or equal to 45 phr, preferably less than 45 phr, more preferably less than or equal to 40 phr, still more preferably less than 40 phr, particularly less than or equal to 35 phr, more particularly less than 35 phr, still more particularly less than or equal to 30 phr, advantageously less than 30 phr, more advantageously less than or equal to 25 phr, still more advantageously less than 25 phr, especially less than or equal to 20 phr.

According to a preferred embodiment of the third aspect, wherein the total amount of the elastomer is more than 0 phr, preferably more than or equal to 5 phr, more preferably more than 5 phr, still more preferably more than or equal to 10 phr, particularly more than 10 phr, more particularly more than or equal to 15 phr, still more particularly more than 15 phr, advantageously more than or equal to 20 phr.

According to a preferred embodiment of the second aspect or the third aspect, wherein the elastomer matrix comprises at least one butyl rubber and at least one elastomer selected from the group consisting of an isoprene elastomer and a butadiene elastomer, preferably wherein the elastomer is an isoprene elastomer.

According to a more preferred embodiment of the above preferred embodiment, the elastomer matrix in the rubber composition according to the invention consists of the butyl rubber and the isoprene elastomer.

According to another more preferred embodiment of the above preferred embodiment, the elastomer matrix in the rubber composition according to the invention comprises the butyl rubber, the isoprene elastomer and another elastomer or other elastomers than the butyl rubber and the isoprene elastomer.

Use may be made, as such, of any elastomer known to a person skilled in the art which is not defined above as the butyl rubber, the isoprene elastomer or the butadiene elastomer.

The rubber composition according to the invention is based on a reinforcing filler.

Use may be made of any type of reinforcing filler known for its capabilities of reinforcing a rubber composition which can be used for the manufacture of the rubber product, for example a reinforcing organic filler, such as at least one carbon black, or a reinforcing inorganic filler, such as a silica (SiO₂), an alumina (Al₂O₃) or a combination thereof, with which at least one coupling agent is combined in a known way.

According to a preferred embodiment of the invention, the reinforcing filler in the rubber composition according to the invention comprises a reinforcing organic filler, preferably at least one carbon black, more preferably representing more than 50% by weight, still more preferably more than 60% by weight, particularly more than 70% by weight, more particularly more than 80% by weight, still more particularly more than 90% by weight, advantageously 100% by weight, per 100% by weight of the reinforcing filler.

A fourth aspect of the invention is the rubber composition according to any one of the first to the third aspects, wherein the reinforcing filler comprises at least one carbon black, and wherein the total amount of the carbon black is more than 50% by weight, preferably more than 55% by weight, more preferably more than 60% by weight, still more preferably more than 65% by weight, particularly more than 70% by weight, more particularly more than 75% by weight, still more particularly more than 80% by weight, advantageously more than 85% by weight, more advantageously more than 90% by weight, still more advantageously more than 95% by weight, especially 100% by weight, per 100% by weight of the reinforcing filler.

The carbon black weight fraction may be measured by thermogravimetric analysis (TGA) in accordance with standard NF T-46-07, on an instrument from the company Mettler Toledo, model “TGA/DSC1”. Approximately 20 g of sample may be introduced into the thermal analyzer, then subjected to a thermal program from 25° C. to 600° C. under an inert atmosphere (pyrolysable phase), then from 400° C. to 750° C. under an oxidizing atmosphere (oxidizable phase). The weight of the sample may be measured continuously throughout the thermal program. The organic matter content may correspond to the loss of weight measured during the pyrolysable phase related back to the initial weight of sample. The amount of carbon black may correspond to the loss of weight measured during the oxidizable phase related back to the initial weight of sample.

As carbon blacks, all carbon blacks, in particular blacks of the SAF, ISAF, HAF, FEF, GPF, HMF, SRF, and SRF type, conventionally used in tires (“tire-grade” blacks) are suitable, such as for example reinforcing carbon blacks of the 100, 200 or 300 series in ASTM grades (such as for example, the N115, N134, N234, N326, N330, N339, N347 or N375 blacks), or carbon blacks higher series, the 500, 600, 700, 800 or 900 series in ASTM grades (such as for example the N550, N660, N683, N772, N774, N880, N990, N991 blacks).

According to a preferred embodiment of the fourth aspect, the carbon black exhibits a BET surface area (in accordance with ASTM D6556-10) of more than 0 m²/g, preferably more than 5 m²/g, more preferably more than 10 m²/g, still more preferably more than 15 m²/g, particularly more than 20 m²/g, more particularly more than 25 m²/g, still more particularly more than 30 m²/g.

According to a preferred embodiment of the fourth aspect, the carbon black exhibits a BET surface area (in accordance with ASTM D6556-10) of less than 140 m²/g, preferably less than 130 m²/g, more preferably less than 120 m²/g, still more preferably less than 110 m²/g, particularly less than 100 m²/g, more particularly less than 90 m²/g, still more particularly less than 80 m²/g, advantageously less than 70 m²/g, more advantageously less than 60 m²/g, still more advantageously less than 50 m²/g, especially less than 40 m²/g.

According to a preferred embodiment of the fourth aspect, the carbon black exhibits an oil absorption number of compressed Sample (COAN: compressed oil absorption number) (in accordance with ASTM D3493-16) of more than 40 ml/100 g, preferably more than 45 ml/100 g, more preferably more than 50 ml/100 g, still more preferably more than 55 ml/100 g, particularly more than 60 ml/100 g, more particularly more than 65 ml/100 g, still more particularly more than 70 ml/100 g.

According to a preferred embodiment of the fourth aspect, the carbon black exhibits an oil absorption number of compressed Sample (COAN: compressed oil absorption number) (in accordance with ASTM D3493-16) of less than 120 ml/100 g, preferably less than 115 ml/100 g, more preferably less than 110 ml/100 g, still more preferably less than 105 ml/100 g, particularly less than 100 ml/100 g, more particularly less than 95 ml/100 g, more particularly less than 90 ml/100 g, still more particularly less than 85 ml/100 g, advantageously less than 80 ml/100 g.

A fifth aspect of the invention is the rubber composition according to any one of the first to the fourth aspect, wherein the total amount of the reinforcing filler is more than 0.0 phr and less than 110 phr.

According to a preferred embodiment of the fifth aspect, the total amount of the reinforcing filler is less than or equal to 105 phr, preferably less than 105 phr, more preferably less than or equal to 100 phr, still more preferably less than 100 phr, particularly less than or equal to 95 phr, more particularly less than 95 phr, still more particularly less than or equal to 90 phr, advantageously less than 90 phr, more advantageously less than or equal to 85 phr, still more advantageously less than 85 phr, especially less than or equal to 80 phr, more especially less than 80 phr.

According to a more preferred embodiment of the above preferred embodiment, the total amount of the reinforcing filler is less than or equal to 75 phr, preferably less than 75 phr, more preferably less than or equal to 70 phr, still more preferably less than 70 phr, particularly less than or equal to 65 phr, more particularly less than 65 phr, still more particularly less than or equal to 60 phr, advantageously less than 60 phr, more advantageously less than or equal to 55 phr, still more advantageously less than 55 phr, especially less than or equal to 50 phr.

According to a preferred embodiment of the fifth aspect, the total amount of the reinforcing filler is more than or equal to 5.0 phr, preferably more than 5.0 phr, more preferably more than or equal to 10 phr, still more preferably more than 10 phr, particularly more than or equal to 15 phr, more particularly more than 15 phr, still more particularly more than or equal to 20 phr, advantageously more than 20 phr, more advantageously more than or equal to 25 phr, still more advantageously more than 25 phr.

According to a more preferred embodiment of the above preferred embodiment, the total amount of the reinforcing filler is more than or equal to 30 phr, preferably more than 30 phr, more preferably more than or equal to 35 phr, still more preferably more than 35 phr, particularly more than or equal to 40 phr, more particularly more than 40 phr, still more particularly more than or equal to 45 phr, advantageously more than 45 phr, more advantageously more than or equal to 50 phr.

The rubber composition according to the invention is based on a plasticizing agent comprising a hydrocarbon resin.

A sixth aspect of the invention is the rubber composition according to any one of the first to the fifth aspects, wherein the plasticizing agent further comprises a liquid plasticizer, preferably wherein a ratio of the total amount by weight of the reinforcing filler to that of the plasticizing agent is less than 8, preferably less than 7.

According to a preferred embodiment of the sixth aspect embodiment, a ratio of the total amount by weight of the reinforcing filler to that of the plasticizing agent is more than 2, preferably more than 3, more preferably more than 4, still more preferably more than 5.

Any extending oil, whether of aromatic or non-aromatic nature, any liquid plasticizing agent known for its plasticizing properties with regard to the elastomer matrix, for instance, diene elastomers, can be used as the liquid plasticizers to soften the matrix by diluting the elastomer and the reinforcing filler. At ambient temperature (20° C.) under atmospheric pressure, these plasticizers or these oils, which are more or less viscous, are liquids (that is to say, as a reminder, substances that have the ability to eventually take on the shape of their container), as opposite to plasticizing hydrocarbon resins which are by nature solid at ambient temperature (20° C.) under atmospheric pressure.

According to a preferred embodiment of the sixth aspect, the liquid plasticizer is selected from the group consisting of a liquid diene polymer, a polyolefinic oils, a naphthenic oil, a paraffinic oil, a Distillate Aromatic Extract (DAE) oil, a Medium Extracted Solvate (MES) oil, a Treated Distillate Aromatic Extract (TDAE) oil, a Residual Aromatic Extract (RAE) oil, a Treated Residual Aromatic Extract (TRAE) oil, a Safety Residual Aromatic Extract (SRAE) oil, a mineral oil, a vegetable oil, an ether plasticizer, an ester plasticizers, a phosphate plasticizer, a sulfonate plasticizer and a combination thereof.

According to a preferred embodiment of the sixth aspect, the total amount of the liquid plasticizer is more than 5.0 phr, preferably more than 5.5 phr, more preferably more than or equal to 6.0 phr.

According to a preferred embodiment of the sixth aspect, the total amount of the liquid plasticizer is less than 20 phr, preferably less than 15 phr, more preferably less than 10 phr.

The hydrocarbon resins are polymer well known by a person skilled in the art, which are essentially based on carbon and hydrogen, and thus miscible by nature in rubber compositions, for instance, diene elastomer compositions. They can be aliphatic or aromatic or also of the aliphatic/aromatic type, that is to say based on aliphatic, aromatic or both monomers. They can be natural or synthetic and may or may not be petroleum-based (if such is the case, also known under the name of petroleum resins). They are preferably exclusively hydrocarbon, that is to say, that they comprise only carbon and hydrogen atoms.

According to a preferred embodiment of the invention, the hydrocarbon resin as being “plasticizing” exhibits at least one, preferably all, of the following characteristics:
a Tg_{DSC} of more than 20° C. (for example, between 20° C. and 400° C.), preferably more than 30° C. (for example, between 30° C. and 300° C.), more preferably more than 40° C. (for example, between 40° C. and 200° C.);
a number-average molecular weight (Mn) of between 400 and 2000 g/mol (preferably between 500 and 1500 g/mol);
a polydispersity index (PI) of less than 3, preferably less than 2 (reminder: PI=Mw/Mn with Mw the weight-average molecular weight).

The macrostructure (Mw, Mn and PI) of the hydrocarbon resin is determined by steric exclusion chromatography (SEC): solvent tetrahydrofuran; temperature 35° C.; concentration 1 g/l; flow rate 1 ml/min; solution filtered through a filter with a porosity of 0.45 μm before injection; Moore calibration with polystyrene standards; set of 3 “Waters” columns in series (“Styragel” HR4E, HR1 and HR0.5); detection by differential refractometer (“Waters 2410”) and its associated operating software (“Waters Empower”).

The hydrocarbon resin in the plasticizing agent of the rubber composition according to the invention comprises more than 0.0 phr and less than 20 phr of a tackfying resin.

According to a preferred embodiment of the invention, the total amount of the tackifying resin in the hydrocarbon resin of the plasticizing agent of the rubber composition according to the invention is more than 0.2 phr, preferably more than 0.4 phr, more preferably more than 0.6 phr, still more preferably more than 0.8 phr, particularly more than 1.0 phr, more particularly more than 1.2 phr, still more particularly more than 1.4 phr, advantageously more than 1.6 phr, more advantageously more than 1.8 phr, still more advantageously more than 2.0 phr, especially more than 2.2 phr, more especially more than 2.4 phr, still more especially more than 2.6 phr, specially more than 2.8 phr, more specially more than or equal to 3.0 phr.

According to a preferred embodiment of the invention, the total amount of the tackifying resin in the hydrocarbon resin of the plasticizing agent of the rubber composition according to the invention is less than 19 phr, preferably less than 18 phr, more preferably less than 17 phr, still more preferably less than 16 phr, particularly less than 15 phr, more particularly less than 14 phr, still more particularly less than 13 phr, advantageously less than 12 phr, more advantageously less than 11 phr, still more advantageously less than 10 phr, especially less than 9.0 phr, more especially less than 8.0 phr, still more especially less than 7.0 phr, specially less than 6.0 phr, more specially less than to 5.0 phr, still more specially less than 4.0 phr.

A seventh aspect of the invention is the rubber composition according to the sixth aspect, wherein the total amount by weight of the liquid plasticizer is more than that of the tackifying resin.

An eighth aspect of the invention is the rubber composition according to any one of the first to the seventh aspects, wherein the tackifying resin exhibits a softening point of more than 50° C. and less than 130° C.

The softening point is measured according to Standard ISO 4625 (“Ring and Ball” method).

According to a preferred embodiment of the eighth aspect, wherein the softening point of the tackifying resin is more than or equal to 55° C., preferably more than 55° C., more preferably more than or equal to 60° C., still more preferably more than 60° C., particularly more than or equal to 65° C., more particularly more than 65° C., still more particularly more than or equal to 70° C., advantageously more than 70° C., more advantageously more than or equal to 75° C., still more advantageously more than 75° C., especially more than or equal to 80° C., more especially more than 80° C., still more especially more than or equal to 85° C.

According to a preferred embodiment of the eighth aspect, wherein the softening point of the tackifying resin is less than or equal to 125° C., preferably less than 125° C., more preferably less than or equal to 120° C., still more preferably less than 120° C., particularly less than or equal to 115° C., more particularly less than 115° C., still more particularly less than or equal to 110° C., advantageously less than 110° C., more advantageously less than or equal to 105° C., still more advantageously less than 105° C., especially less than or equal to 100° C., more especially less than 100° C., still especially less than or equal to 95° C.

A ninth aspect of the invention is the rubber composition according to any one of the first to eighth aspects, wherein the tackifying resin is selected from the group consisting of a rosin, a rosin derivative, a coumarone resin, a phenolic resin, a terpene resin (α-pine, β-pine or limonene), a terpene/phenol resin, a C₅ fraction resin, a C₉ fraction resin, a C₅/C, fraction resin, a cyclopentadiene rein, a dicyclopentadiene resin, a cyclopentadiene/dicyclopentadiene resin, a α-methylstyrene resin and a combination thereof, preferably selected from the group consisting of a phenolic resin and a C₅ fraction resin and a combination thereof, more preferably selected from the group consisting of a phenolic resin and a combination thereof, still more preferably selected from the group consisting of an alkylphenol resin and a combination thereof, particularly selected from group consisting of an alkylphenol/formaldehyde resin, an alkylphenol/acetylene resin and a combination thereof, more particularly selected from the group consisting of an alkylphenol/formaldehyde resin and a combination thereof, still more particularly wherein the tackifying resin is octylphenol/formaldehyde resin.

The rubber composition according to the invention is based on a crosslinking (vulcanization) system.

The crosslinking system in the rubber composition according to the invention comprises a vulcanizing agent.

The vulcanizing agent is also called “vulcanization agent”, “curative” or “curing agent”.

The vulcanizing agent in the crosslinking system of the rubber composition according to the invention comprises more than 0.0 phr and less than 10 phr of a sulfur doner comprising N,N′-Caprolactam disulfide.

According to a preferred embodiment of the invention, the total amount of the sulfur doner in the vulcanizing agent of the crosslinking system of the rubber composition according to the invention is more than or equal to 0.1 phr, preferably more than 0.1 phr, more preferably more than or equal to 0.2 phr, still more preferably more than 0.2 phr, particularly more than or equal to 0.3 phr, more particularly more than 0.3 phr, still more particularly more than or equal to 0.4 phr, advantageously more than 0.4 phr, more advantageously more than or equal to 0.5 phr, still advantageously more than 0.5 phr, especially more than or equal to 0.6 phr, more especially more than 0.6 phr, still more especially more than or equal to 0.7 phr, specially more than 0.7 phr, more specially more than or equal to 0.8 phr, still more specially more than 0.8 phr.

According to a preferred embodiment of the invention, the total amount of the sulfur doner in the vulcanizing agent of the crosslinking system of the rubber composition according to the invention is less than 9.5 phr, preferably less than 9.0 phr, more preferably less than 8.5 phr, still more preferably less than 8.0 phr, particularly less than 7.5 phr, more particularly less than 7.0 phr, still more particularly less than 6.5 phr, advantageously less than 6.0 phr, more advantageously less than 5.5 phr, still advantageously less than 5.0 phr, especially less than 4.5 phr, more especially less than 4.0 phr, still more especially less than 3.5 phr, specially less than 3.0 phr, more specially less than 2.5 phr, still more specially less than 2.0 phr.

According to a more preferred embodiment of the preferred embodiment, the total amount of the sulfur doner in the vulcanizing agent of the crosslinking system of the rubber composition according to the invention is less than 1.5 phr, preferably less than 1.4 phr, more preferably less than 1.3 phr, still more preferably less than 1.2 phr, particularly less than 1.1 phr, more particularly less than 1.0 phr, still more particularly less than 0.9 phr.

A tenth aspect of the invention is the rubber composition according to any one of the first to the ninth aspects, wherein the total amount of N,N′-Caprolactam disulfide (DTDC) is more than 50% by weight, preferably more than or equal to 55% by weight, more preferably more than 55% by weight, still more preferably more than or equal to 60% by weight, particularly more than 60% by weight, more particularly more than or equal to 65% by weight, still more particularly more than 65% by weight, advantageously more than or equal to 70% by weight, more advantageously more than 70% by weight, still more advantageously more than or equal to 75% by weight, especially more than 75% by weight, more especially more than or equal to 80% by weight, per 100% by weight of the sulfur doner.

According to a preferred embodiment of the invention, the total amount of N,N′-Caprolactam disulfide (DTDC) in the sulfur doner in the vulcanizing agent of the crosslinking system of the rubber composition according to the invention is less than or equal to 100% by weight, preferably less than 100% by weight, more preferably less than or equal to 95% by weight, still more preferably less than 95% by weight, particularly less than or equal to 90% by weight, more particularly less than 90% by weight, still more particularly less than or equal to 85% by weight, advantageously less than 85% by weight, more advantageously less than or equal to 80% by weight, per 100% by weight of the sulfur doner.

According to a preferred embodiment of the invention, the sulfur doner in the vulcanizing agent of the crosslinking system of the rubber composition according to the invention comprises disulfide and N,N′-Caprolactam disulfide (DTDC), and the sulfur doner further comprises at least one elastomer binder (for example, EPDM/ethylene-vinyl acetate (EVA, EVM)) and dispersants, preferably the total amount of the elastomer binder and the dispersants is more than 0% by weight and less than 50% by weight, more preferably less than or equal to 45% by weight, still more preferably less than 45% by weight, particularly less than or equal to 40% by weight, more particularly less than 40% by weight, still more particularly less than or equal to 35% by weight, advantageously less than 35% by weight, more advantageously less than or equal to 30% by weight, still more advantageously less than 30%, especially less than or equal to 25% by weight, more especially less than 25% by weight, still more especially less than or equal to 20%.

An eleventh aspect of the invention is the rubber composition according to any one of the first to the tenth aspects, wherein the total amount of N,N′-Caprolactam disulfide is more than 0.0 phr and less than 8.0 phr.

According to a preferred embodiment of the eleventh aspect, the total amount of N,N′-Caprolactam disulfide (DTDC) in the sulfur doner in the vulcanizing agent of the crosslinking system of the rubber composition according to the invention is more than or equal to 0.1 phr, preferably more than 0.1 phr, more preferably more than or equal to 0.2 phr, still more preferably more than 0.2 phr, particularly more than or equal to 0.3 phr, more particularly more than 0.3 phr, more particularly more than or equal to 0.4 phr, still more particularly more than 0.4 phr, advantageously more than or equal to 0.5 phr, more advantageously more than 0.5 phr, still more advantageously more than or equal to 0.6 phr.

According to a preferred embodiment of the eleventh aspect, the total amount of N,N′-Caprolactam disulfide (DTDC) in the sulfur doner in the vulcanizing agent of the crosslinking system of the rubber composition according to the invention is less than 7.5 phr, preferably less than 7.0 phr, more preferably less than 6.5 phr, still more preferably less than 6.0 phr, particularly less than 5.5 phr, more particularly less than 5.0 phr, still more particularly less than 4.5 phr, advantageously less than 4.0 phr, more advantageously less than 3.5 phr, still more advantageously less than 3.0 phr, especially less than 2.5 phr, more especially less than 2.0 phr, still more especially less than 1.5 phr, specially less than 1.0 phr, more specially less than 0.9 phr, still more specially less than 0.8 phr.

According to a preferred embodiment of the invention, the vulcanizing agent in the crosslinking system of the rubber composition according to the invention further comprises a sulfur donner other than N,N′-Caprolactam disulfide, for example, alkylphenol disulfide (abbreviated as “APDS”, for instance, para-(tert butyl) phenol disulfide), N,N′-Dimorpholine Disulfide or a combination thereof.

According to another preferred embodiment of the invention, the vulcanizing agent in the crosslinking system of the rubber composition according to the invention does not comprise any sulfur donner other than N,N′-Caprolactam disulfide.

A twelfth aspect of the invention is the rubber composition according to any one of the first to the eleventh aspects, wherein the vulcanizing agent comprises neither a soluble sulfur nor an insoluble sulfur, or wherein the vulcanizing agent further comprises sulfur selected from the group consisting of a soluble sulfur, an insoluble sulfur and a combination thereof, and the total amount by weight of the sulfur selected from the group consisting of a soluble sulfur, an insoluble sulfur and a combination thereof is lower than that of that of the sulfur donner.

A thirteenth aspect of the invention is the rubber composition according to the twelfth aspect, wherein the total amount by weight of the sulfur selected from the group consisting of a soluble sulfur, an insoluble sulfur and a combination thereof is less than 0.4 phr, preferably less than or equal to 0.3 phr, more preferably less than 0.3 phr, still more preferably less than or equal to 0.2 phr, particularly less than 0.2 phr, more particularly less than or equal to 0.1 phr, still more particularly less than 0.1 phr, advantageously wherein the vulcanizing agent comprises neither a soluble sulfur nor an insoluble sulfur.

According to a preferred embodiment of the invention, the vulcanizing agent in the crosslinking system of the rubber composition according to the invention further comprises a peroxide, a bismaleimide or a combination thereof.

According to another preferred embodiment of the invention, the vulcanizing agent in the crosslinking system of the rubber composition according to the invention comprises neither a peroxide nor a bismaleimide.

A fourteenth aspect of the invention is the rubber composition according to any one of the first to the thirteenth aspects, wherein the crosslinking system further comprises at least one vulcanization accelerator, and wherein the total amount by weight of the vulcanization accelerator is more than that of the sulfur donner, preferably wherein the vulcanization accelerator is a primary vulcanization accelerator, more preferably selected from the group consisting of an accelerator of sulfonamide type, an accelerator of thiazole type, an accelerator of thiuram type, an accelerator of dithiocarbamate type and a combination thereof.

According to a preferred embodiment of the fourteenth aspect, the accelerator of sulfonamide type is selected from the group consisting of N-Cyclohexyl-2-benzothiazolesulfenamide (abbreviated as “CBS”), N-(tert-Butyl)-2-benzothiazolesulfonamide (abbreviated as “TBBS”), N-tert-Butyl-2-benzothiazolesulfenimide (abbreviated as “TBSI”), N-Oxydi-ethylene-2-benzothiazolesulfonamide (abbreviated as “MBS”), N,N′-dicyclohexyl-2-benzothiazolesulfonamide (abbreviated as “DCBS”) and a combination thereof.

According to a preferred embodiment of the fourteenth aspect, the accelerator of thiazole type is selected from the group consisting of 2-mercaptobenzothiazole (abbreviated as “MBT”), 2-mercaptobenzothiazyl disulfide (abbreviated as “MBTS”), Zinc-2-mercaptobenzothiazole (abbreviated as “ZMBT”), 2-(Morpholinothio)benzothiazole (abbreviated as “MDB”) and a combination thereof.

According to a preferred embodiment of the fourteenth aspect, the accelerator of thiuram type is selected from the group consisting of Tetramethylthiuram Disulfide (abbreviated as “TMTD”), Tetraethylthiuram Disulfide (abbreviated as “TETD”), Tetrabutylthiuram disulfide (abbreviated as “TBTD”), Tetrakis(2-ethylhexyl) thiuram disulfide (abbreviated as “TOT-N”), Tetramethylthiuram Monosulfide (abbreviated as “TMTM”), Dipentamethylenethiuram Tetrasulfide (abbreviated as “DPTT”), Tetrabenzylthiuram Disulfide (abbreviated as “TBzTD”) and a combination thereof.

According to a preferred embodiment of the fourteenth aspect, the accelerator of dithiocarbamate type is selected from the group consisting of Zinc Dimethyldithio-carbamate (abbreviated as “ZDMC”), Zinc Diethyldithiocarbamate (abbreviated as “ZDEC”), Zinc Dibutyldithiocarbamate (abbreviated as “ZDBC”), Zinc Ethylphenyldithiocarbamate (abbreviated as “ZEPC”), Zinc Dibenzyldithiocarbamate (abbreviated as “ZDBzC”), Zinc N-pentamethylenedithiocarbamate (abbreviated as “ZPDC”) and a combination thereof.

According to a preferred embodiment of the fourteenth aspect, the total amount of the vulcanization accelerator is more than 0.0 phr, preferably more than 0.1 phr, more preferably more than 0.2 phr, still more preferably more than 0.3 phr, particularly more than 0.4 phr, more particularly more than 0.5 phr, still more particularly more than 0.6 phr, advantageously more than 0.7 phr, more advantageously more than 0.8 phr, still more advantageously more than 0.9 phr, especially more than 1.0 phr, more especially more than 1.1 phr, still more especially more than 1.2 phr, specially more than 1.3 phr, more specially more than 1.4 phr, still more specially more than 1.5 phr.

According to a preferred embodiment of the fourteenth aspect, the total amount of the vulcanization accelerator is less than 5.0 phr, preferably less than 4.8 phr, more preferably less than 4.6 phr, still more preferably less than 4.4 phr, particularly less than 4.2 phr, more particularly less than 4.0 phr, still more particularly less than 3.8 phr, advantageously less than 3.6 phr, more advantageously less than 3.4 phr, still more advantageously less than 3.2 phr, especially less than 3.0 phr, more especially less than 2.8 phr, still more especially less than 2.6 phr, specially less than 2.4 phr, more specially less than 2.2 phr, still more specially less than 2.0 phr.

According to a preferred embodiment of the invention, the crosslinking system in the rubber composition according to the invention comprises a vulcanization retarder, for example N-cyclohexylthiophthalimide (abbreviated as “CTP”).

According to a preferred embodiment of the invention, the crosslinking system in the rubber composition according to the invention comprises a vulcanization activator, preferably selected from the group consisting of zinc oxide, fatty acid, zinc fatty acid ester, a guanidine derivative or a combination thereof.

According to a more preferred embodiment of the above preferred embodiment, the fatty acid is stearic acid, lauric acid, palmitic acid, oleic acid, naphthenic acid or a combination thereof.

According to a more preferred embodiment of the above preferred embodiment, the zinc fatty acid ester is zinc stearic acid, zinc lauric acid, zinc palmitic acid, zinc oleic acid, zinc naphthenic acid or a combination thereof.

According to a more preferred embodiment of the above preferred embodiment, the guanidine derivative is diphenylguanidine.

The rubber compositions according to the invention may be based on all or at least one portion of the usual additives generally used in the rubber compositions intended for rubber products, such as protection agents (for example, anti-ozone waxes, chemical antiozonants, antioxidants or combinations thereof), pigments, anti-fatigue agents, processing acids or combinations thereof.

The rubber compositions according to the invention can be used alone or as a blend (i.e., as a mixture) with any other rubber composition which can be used for the manufacture of rubber products.

It goes without saying that the invention relates to the rubber compositions described previously both in the uncured state or non-crosslinked state or also raw state (i.e., before curing) and in the cured state or crosslinked state or also vulcanized, state (i.e., after crosslinking or vulcanization).

According to a preferred embodiment of the invention, the rubber composition according to the invention is further based on a crosslinking system comprising a vulcanizing agent, a vulcanization accelerator, a vulcanization retarder, a vulcanization activator or a combination thereof, and the rubber composition according to the invention is manufactured in a mixer using two successive preparation phases: a first phase of thermomechanical working or kneading (referred to as “non-productive” phase) at high temperature, up to a maximum temperature of more than 110° C. and less than 200° C., preferably more than 110° C. and less than 190° C., more preferably more than 130° C. and less than 180° C., followed by a second phase of mechanical working (referred to as “productive” phase) at a lower temperature of less than or equal to 110° C., preferably more than 40° C. and less than 100° C., more preferably more than 60° C. and less than 100° C., finishing phase during which the vulcanizing agent, the vulcanization accelerator and the vulcanization retarder or the combination thereof in the crosslinking system is incorporated. According to a more preferred embedment of the above preferred embodiment, the vulcanization activator is incorporated during the first non-productive phase, during the productive phase or during both of the phases, preferably during the first non-productive phase.

According to a more preferred embodiment of the above preferred embodiment, the first phase (the non-productive phase) is performed in several thermomechanical steps: during the first step in the several thermomechanical steps, the elastomer matrix, the reinforcing filler (and optionally the plasticizing agent, other ingredients or combinations thereof, with the exception of the vulcanizing agent, the vulcanization accelerator, the vulcanization retarder or the combination thereof in the crosslinking system) are introduced into a mixer (preferably an internal mixer) at a temperature of more than 20° C. and less than 100° C., preferably more than 25° C. and less than 100° C.; and after a few minutes, preferably from 0.5 minutes to 2 minutes, and a rise in the temperature to 90° C. or more (preferably, 100° C.), the elastomer matrix, the other ingredient and the combination thereof (that is to say, those which remain, if not all were introduced into the mixer in the first step (the non-productive phase)) are added all at once or portionwise, with the exception of the vulcanizing agent, the vulcanization accelerator, the vulcanization retarder or the combination thereof in the crosslinking system, during a compounding ranging from 20 seconds to a few minutes; wherein the total duration of the kneading, in the first phase (the non-productive phase), is preferably more than 1 minute and less than 15 minutes, more preferably more than 2 minutes and less than 10 minutes, at a temperature of less than or equal to 190° C., preferably less than or equal to 180° C., more preferably of less than or equal to 170° C.

According to a still more preferred embodiment of the above preferred embodiment or the above more preferred embodiment, after cooling of the mixture thus obtained, the vulcanizing agent, the vulcanization accelerator, the vulcanization retarder or the combination thereof in the crosslinking system is then incorporated at low temperature, preferably of less than or equal to 100° C., more preferably less than or equal to 90° C., in an external mixer, preferably an open mill; the whole is then mixed in the second phase (the productive phase) for a few minutes, preferably more than 2 minutes and less than 15 minutes, more preferably more than 5 minutes and less than 15 minutes.

According to a particular embodiment of the above preferred embodiment, the above more preferred embodiment or the above still more preferred embodiment, the rubber composition thus obtained in the mixer using two successive preparation phases is subsequently calendered, for example in the form of a sheet or of a plaque, in particular for laboratory characterization, or else extruded in the form of a rubber profiled element able to be used directly as a rubber product.

According to a more particular embodiment of the above preferred embodiment, the above more preferred embodiment, the above still more preferred embodiment or the above particular embodiment, the crosslinking (or curing) is performed in a known manner at a temperature of more than 110° C. and less than 200° C., preferably more than 130° C. and less than 190° C., under pressure, for a sufficient time which may range, for example, between 5 and 90 mm, as a function notably of the curing temperature, of the crosslinking system adopted, of the kinetics of crosslinking of the rubber composition under consideration or else of the size of the rubber product.

A fifteenth aspect is a rubber product comprising a rubber composition according to any one of the first to the fourteenth aspects, preferably wherein the rubber product comprising a rubber part comprising a rubber composition according to any one of the first to the fourteenth aspects, more preferably wherein the rubber part is a tire tread, a tire sidewall, a tire rim cushion, a tire sidewall reinforcement, a tire belt skim, a tire belt cushion, a tire inner liner, a tire bead filler, a tire carcass topping, a shoe sole, a rubber track tread, a rubber track pad, an anti-vibration mount, a conveyor belt, a timing belt, a power transmission belt, a hose, a flooring, a gasket, a molded mechanical part, a seal or recyclate in thermoplastic vulcanizate, still more preferably wherein the rubber product is a tire, a shoe, a rubber track or an industrial rubber product, particularly wherein the rubber product is a tire, more particularly wherein the rubber product is a tire comprising a rubber part which is a tire inner liner comprising a rubber composition according to any one of the first to the fourteenth aspects. The tire inner liner is a rubber layer that is designed to prevent airflow and to maintain the high air pressure of a tire.

According to a preferred embodiment of the invention, a tire comprises a rubber composition according to any one of the first to the fourteenth aspects, preferably wherein the tire comprises an inner liner comprising a rubber composition according to any one of the first to the fourteenth aspects.

The above tires of the invention are particularly intended to equip passenger motor vehicles, including 4×4 (four-wheel drive) vehicles and SUV (Sport Utility Vehicles) vehicles, and industrial vehicles particularly selected from vans and heavy duty vehicles (i.e., bus or heavy road transport vehicles (lorries, tractors, trailers)).

The invention is further illustrated by the following non-limiting examples.

### EXAMPLE

In order to confirm the effect of the invention, seventh rubber compositions (C1 to C3: examples according to the invention, T1 and T3: references, and T2 and T4: comparative examples) were used. Each of the rubber compositions is based on elastomers (a combination of natural rubber (abbreviated as “NR”) and a butyl rubber as an elastomer matrix) reinforced with a carbon black (as a reinforcing filler), a plasticizing agent (a naphthenic process oil (as a liquid plasticizing agent) and an octylphenol/formaldehyde resin or an aliphatic resin (as a hydrocarbon resin, a tackifying resin)) and a vulcanizing agent that is a soluble sulfur, N, N′-Caprolactam disulfide as a sulfur donner or both. Each of the formulations of the rubber compositions is shown in Table 1 with the amount of the various products expressed in phr.

Each rubber composition was produced as follows: The reinforcing filler, the elastomer matrix, the plasticizing agent and the various other ingredients, with the exception of the vulcanizing agent (the soluble sulfur, N, N′-Caprolactam disulfide as the sulfur donner or both), a vulcanization accelerator (2-mercaptobenzothiazyl disulfide (abbreviated as “MBTS”)) with or without a vulcanization retarder (N-cyclohexylthiophthalimide (abbreviated as “CTP”)) in a crosslinking system, were successively introduced into an internal mixer having an initial vessel temperature of approximately 60° C.; the mixer was thus approximately 70% full (% by volume). Thermomechanical working (non-productive phase) was then carried out in one stage, which lasts in total approximately 3 minutes to 4 minutes, until a maximum “dropping” temperature of 165° C. was reached. The mixture thus obtained was recovered and cooled and then the vulcanizing agent and the vulcanization accelerator in the crosslinking system were incorporated on an external mixer (homofinisher) at 20° C. to 30° C., everything being mixed (productive phase) for an appropriate time (for example, more than 5 minutes and less than 12 minutes).

The rubber compositions thus obtained were subsequently calendered, either in the form of sheets (thickness of 2 to 3 mm) or of fine sheets of rubber, for the measurement of their physical or mechanical properties, or in the form of profiled elements which could be used directly, after cutting, assembling, or both to the desired dimensions, for instance as tire semi-finished products.

Scorch time measurements for the rubber compositions before cured were carried out at 135° C., in accordance with French standard NF T 43-005. The variation of the consistometric index as a function of time makes it possible to determine the scorch time of the rubber compositions, assessed according to the aforementioned standard by the parameter (T₅) (in the case of a large rotor), expressed in minutes, and defined as the time taken to obtain an increase in the consistometric index (expressed in UM) of 5 units above the minimum value measured for this index. If T₅ shown in Table 2 is more than 10 minutes, the scorch time is sufficient, and the longer T₅, the better the performance is.

Rheometry measurements for the rubber compositions before cured were carried out at 150° C. with an oscillating disc rheometer, in accordance with Standard DIN 53529 part 3 (June 1983). The change in the rheometric torque as a function of time describes the change in the stiffening of the composition as a result of the vulcanization reaction. The measurements were processed according to Standard DIN 53529-part 2 (March 1983): T_{α} is the time necessary to achieve a conversion of α %, that is to say α % of the difference between the minimum and maximum torques. The shorter the difference of between T₉₀ and T₁₀ shown in Table 2, the more the rubber composition is rapidly crosslinked, that is to say the curing time is shortened.

The breaking measurements for the rubber compositions after cured were performed at an ambient temperature and in accordance with the French standard NF T 46-002 of September 1988. The breaking specimens for the rubber compositions were of H₂ type as described in the standard NF ISO 37 of 1 Mar. 2012, with the exception of the thickness, which was 2.5 cm. The force to be exerted to obtain breaking (breaking stress, in MPa (in N/mm)) was determined and the elongation at break (in %) was measured.

Thus, the energy to bring about breaking (breaking energy) of the specimen, which was the product of the breaking stress and the elongation at break (breaking energy=breaking stress×elongation at break) was determined.

The results shown in Table 2 are indicated on a basis of 100; the arbitrary value 100 is attributed to the reference (T1), respectively, for the breaking stress and for the breaking energy. A result of less than 100 for the breaking stress or the breaking energy indicates a decrease in the value concerned, which corresponds to a reduction in the breaking strength performance, and, conversely, a result greater than 100 indicates an increase in this value, which corresponds to an improvement in this performance.

The values of the permeability to oxygen were measured using a Mocon Oxtran 2/61 permeability “tester” at 40° C. Cured samples in the form of dises with a predetermined thickness (approximately 0.8 to 1 mm) were fitted to the device and rendered leaktight with vacuum grease. One of the faces of the disc was kept under 15 psi of nitrogen while the other face is kept under 15 psi of oxygen (1 psi=6894.76 Pa). The increase in the oxygen concentration was monitored using a “Coulox” oxygen detector on the face kept under nitrogen. The oxygen concentration on the face kept under nitrogen which made it possible to achieve a constant value, used to determine the permeability to oxygen, was recorded.

The results (performance of impermeability to oxygen) are expressed in base 100, that is to say that the value 100 is arbitrarily assigned to the reference (T3), and then the values of the examples (C1, C2 and C3) according to the invention and the comparative examples (T1 and T2) are shown in Table 2. The values, each which corresponds to Permeability to oxygen (T3)/Permeability to oxygen (X)×100, where X is C1, C2, C3, T1 or T2, are calculated. The higher the value is, the lower the permeability to oxygen is, that means the better the performance of impermeability to oxygen is.

Dynamic properties (G′: dynamic shear elastic modulus (or dynamic modulus), G″: viscous shear modulus, tan δ: loss factor, and G*: complex modulus) of the rubber compositions were obtained from measurements on a Metravib VA4000 viscoanalyser on test specimens bonded from the cured rubber compositions. The test specimens such as those described in Standard ASTM D 5992-96 (the version published in September 2006, initially approved in 1996) in Figure X2.1 (circular embodiment) were used. The diameter “d” of the test specimen was 10 mm (it therefore has a circular cross section of 78.5 mm²), the thickness “L” of each of the portions of rubber composition was 2 mm, giving a “d/L” ratio of 5 (in contrast with Standard ISO 2856 mentioned in the ASTM Standard, paragraph X2.4, which recommends a d/L value of 2). The response of a test specimen of vulcanized rubber composition subjected to a simple alternating sinusoidal shear loading at a frequency of 10 Hz and a stabilized temperature at 23° C. was recorded. The test specimens each was loaded symmetrically about its equilibrium position. The sweep covered amplitudes of deformation from 0.1% to 50% (peak-peak: on the outward cycle; 12 measurement points), then from 50% to 0.1% (peak-peak; on the return cycle; 11 measurement points). Following each data acquisition, the dynamic shear elastic modulus (G′) and the viscous shear modulus (G″) on the return cycle, together with the loss factor (tan δ), which corresponds to the ration G″/G′, were calculated. Also, the complex modulus (G*) is defined as the absolute value of the complex sum of the elastic modulus (G′) and viscous modulus (G″): G*=(G′²+G″²)^{0.5}.

Each value of tan δ at 10 Hz and 23° C. is representative of the hysteresis performance of the rubber compositions each, and it is representative of thus of the rolling resistance performance in case of that tires, conveyor belts or rubber tracks comprise the rubber compositions.

The results (hysteresis performance) are expressed in base 100, that is to say that the value 100 is arbitrarily assigned to the reference (T1), and then the values of the examples (C1, C2 and C3) according to the invention and the comparative examples (T2 and T3) are shown in Table 2. The values, each which corresponds to tan δ (T1, 10 Hz, 23° C.)/tan δ (X, 10 Hz, 23° C.)×100, where X is C1, C2, C3, T2 or T3, are calculated. The higher the value is, the lower the hysteresis loss is, that means the better the hysteresis performance is.

Table 2 demonstrates that the examples (C1 to C3) according to the invention have sufficient scorch time (T₅) of more than 10 minutes, but the scorch time (T₅) of the reference (T1) is shorter than 10 minutes.

Table 2 shows that the examples (C1 to C3) according to the invention have shorter curing time (T₉₀-T₁₀) than that of the reference (T1).

Table 2 indicates the examples (C1 to C3) according to the invention have better values of the breaking energy than that of the reference (T1).

Table 2 demonstrates the examples (C to C3) according to the invention have better values of the impermeability to oxygen than that of the reference (T3).

The results from Table 2 demonstrate that the examples (C1 to C3) according to the invention have better values of the hysteresis performance than that of the reference (T1).

Also, tan δ at 10 Hz and 23° C. of an additional comparative example (T4) was additionally measured, and the value of tan δ (T1, 10 Hz, 23° C.)/tan δ (T4, 10 Hz, 23° C.)×100 is 70. The formula of T4 is same as that of C1 apart from that the amount of the tackifying resin (Octylphenol/formaldehyde resin) is 20 phr, but not 3.0 phr.

In conclusion, the rubber composition according to the invention allows being secured the sufficient scorch time while being maintained improved the curing time, the breaking energy performance, the performance of impermeability to oxygen and the hysteresis performance.

TABLE 1

| Compositions | T1 | C1 | C2 | T2 | T3 | C3 | C4 |
|---|---|---|---|---|---|---|---|
| NR (1) | 20 | 20 | 20 | 20 | 20 | 20 | 20 |
| Butyl rubber (2) | 80 | 80 | 80 | 80 | 80 | 80 | 80 |
| Carbon black (3) | 50 | 50 | 50 | 50 | 50 | 53 | 50 |
| Oil (4) | 6.0 | 6.0 | 6.0 | 6.0 | 6.0 | 6.0 | 6.0 |
| Stearic acid (5) | 0.75 | 0.75 | 0.75 | 0.75 | 0.75 | 0.75 | 0.75 |
| Zinc oxide (6) | 1.0 | 1.0 | 1.0 | 1.0 | 1.0 | 1.0 | 1.0 |
| Tackifying resin 1 (7) | 3.0 | 3.0 | 1.5 | 1.5 | | 3.0 | |
| Tackifying resin 2 (8) | | | | | | | 3.0 |
| Accelerator (9) | 1.0 | 1.3 | 1.3 | 1.3 | 1.3 | 1.3 | 1.6 |
| Retarder (10) | 0.5 | 0.5 | 0.5 | 0.5 | 0.5 | 0.5 | 0.5 |
| Soluble sulfur | 0.85 | | | | | | |
| Sulfur donner (11) | | 0.85 | 0.85 | 10 | 0.85 | 0.85 | 0.85 |

(1) Natural rubber;
(2) Brominated polyisobutylene (“Bromobutyl 3220”, sold by Exxon Chemical Co.);
(3) Carbon black (ASTM grade N660 from Cabot, BET (in accordance with ASTM D6556-10): 35 m²/g, COAN: 64 ml/100 g);
(4) Liquid plasticizing agent: Naphthenic process oil (“NYTEX 4700” from NYTEX);
(5) Stearic acid (“Pristerene 4931” from Uniqema);
(6) Zinc oxide (industrial grade from Umicore company);
(7) Tackifying resin 1: Octylphenol/formaldehyde resin (“SP-1068”, Softening point: 90° C., from SI Group);
(8) Tackifying resin 2: Aliphatic resin (“ESCOREZ 1102”, Softening point: 100° C., from ExxonMobil Chemical company);
(9) Vulcanization accelerator: 2-mercaptobenzothiazyl disulfide (“Nocceler DM-P (DM) [MBTS]” from Ouchi Shinko Chemical Industrial);
(10) Vulcanization retarder: N-cyclohexylthiophthalimide (“Vulkalent G” from Lanxess); and
(11) Sulfur doner: N,N′-Caprolactam disulfide (DTDC): 80%, elastomer binder and dispersants: 20% (“Renogrand CLD 80” from Lanxess).

TABLE 2

| Compositions | T1 | C1 | C2 | T2 | T3 | C3 | C4 |
|---|---|---|---|---|---|---|---|
| Scorch time [minutes] | 5.0 | 15.4 | 17.7 | 11.2 | 25.5 | 13.4 | 24.2 |
| Curing time [minutes] | 23.9 | 18.1 | 19.8 | 14.2 | 19.5 | 17.6 | 18.9 |
| Breaking energy | 100 | 102 | 107 | 87 | 102 | 101 | 106 |
| Impermeability to | 130 | 130 | 121 | 130 | 100 | 124 | 119 |
| oxygen | | | | | | | |
| Hysteresis | 100 | 101 | 108 | 124 | 110 | 102 | 102 |
| performance | | | | | | | |

1.-15. (canceled)

16. A rubber composition based on at least:
an elastomer matrix;
a reinforcing filler;
a plasticizing agent; and
a crosslinking system,
wherein the plasticizing agent comprises a hydrocarbon resin comprising more than 0.0 phr and less than 20 phr of a tackfying resin; and
wherein the crosslinking system comprises a vulcanizing agent comprising more than 0.0 phr and less than 10 phr of a sulfur donor comprising N,N′-caprolactam disulfide.

17. The rubber composition according to claim 16, wherein the elastomer matrix comprises at least one butyl rubber.

18. The rubber composition according to claim 16, wherein the elastomer matrix comprises at least one elastomer selected from the group consisting of an isoprene elastomer and a butadiene elastomer.

19. The rubber composition according to claim 16, wherein the reinforcing filler comprises at least one carbon black, and
wherein a total amount of the at least one carbon black is more than 50% by weight per 100% by weight of the reinforcing filler.

20. The rubber composition according to claim 16, wherein a total amount of the reinforcing filler is more than 0.0 phr and less than 110 phr.

21. The rubber composition according to claim 16, wherein the plasticizing agent further comprises a liquid plasticizer.

22. The rubber composition according to claim 21, wherein a total amount by weight of the liquid plasticizer is more than a total amount by weight of the tackifying resin.

23. The rubber composition according to claim 16, wherein the tackifying resin exhibits a softening point of more than 50° C. and less than 130° C.

24. The rubber composition according to claim 16, wherein the tackifying resin is selected from the group consisting of a rosin, a rosin derivative, a coumarone resin, a phenolic resin, a terpene resin, a terpene/phenol resin, a C5 fraction resin, a C9 fraction resin, a C5/C9 fraction resin, a cyclopentadiene rein, a dicyclopentadiene resin, a cyclopentadiene/dicyclopentadiene resin, a α-methylstyrene resin and a combination thereof.

25. The rubber composition according to claim 16, wherein a total amount of N,N′-caprolactam disulfide is more than 50% by weight per 100% by weight of the sulfur donor.

26. The rubber composition according to claim 16, wherein a total amount of N,N′-caprolactam disulfide is more than 0.0 phr and less than 8.0 phr.

27. The rubber composition according to claim 16, wherein the vulcanizing agent does not comprise a soluble sulfur, does not comprise an insoluble sulfur, or comprises sulfur selected from the group consisting of a soluble sulfur, an insoluble sulfur and a combination thereof, where a total amount by weight of the sulfur is lower than a total amount by weight of the sulfur donor.

28. The rubber composition according to claim 27, wherein the vulcanizing agent comprises sulfur selected from the group consisting of a soluble sulfur, an insoluble sulfur and a combination thereof in an amount of less than 0.4 phr.

29. The rubber composition according to claim 16, wherein the crosslinking system further comprises at least one vulcanization accelerator, and
wherein a total amount by weight of the at least one vulcanization accelerator is more than a total amount by weight of the sulfur donor.

30. A rubber product comprising the rubber composition according to claim 16.
